(19) United States
(12) Patent Application Publication
(10) Pub. No.: US 2012/0132047 A1
(43) Pub. Date: May 31, 2012

(54) DEVICE FOR INSTALLING A BLADE SWIVEL IN ROTARY DIE CUTTER

(75) Inventors: Shinya Iori, Mihara-shi (JP); Osamu Hatano, Mihara-shi (JP)

(73) Assignee: MITSUBISHI HEAVY INDUSTRIES PRINTING & PACKAGING MACHINERY, LTD., Mihara-shi, Hiroshima (JP)

(21) Appl. No.: 13/383,362

(22) PCT Filed: Jul. 28, 2010
(86) PCT No.: PCT/JP2010/062702

§ 371 Date: Feb. 7, 2012

(30) Foreign Application Priority Data
Aug. 6, 2009 (JP) 2009-183044

(51) Int. Cl. B26D 7/18; B23P 19/00

(52) U.S. Cl. 83/136; 29/700

(57) ABSTRACT

The objects is to rapidly position and fix a blade swivel to a knife cylinder in a rotary die cutter and to abate abrasion of the inner end of an extrusion member that is brought into contact with an extruding unit. A wooden pattern 22 in which a punching blade 20 is embedded is installed to a blade swivel 18. A knife cylinder 16 includes first penetrating holes 76 accommodating first extruding pins 74 while the blade swivel 18 includes a second penetrating holes 80 accommodating second extruding rod 82. The first extruding pin 74 can be brought into contact with the second extruding rods 82, and an eccentric cylinder 72 extrudes the first extruding pins 74 to further extrude a punched chip a sandwiched between a punching blade 20. At the inner opening of each second penetrating hole 80, a recess groove 98 is formed along the axis direction of the knife cylinder. This configuration prevents the first extruding pins 74 from hitting the blade swivel when the blade swivel 18 moves along the axis direction of the knife cylinder when the blade swivel 18 is to be installed.

The present invention relates to a device for installing a blade swivel, which makes it easy to install a blade swivel to a knife cylinder when a rotary die cutter that is used for processing a corrugated board sheet is to punch, for example, a simple hole through the corrugated board sheet in a corrugated cardboard box maker such as hand hole processing.

### BACKGROUND

In fabricating corrugated cardboard box, a rotary die cutter forms ruled lines and punches holes through corrugated board sheets after subjected to printing. A rotary die cutter has an anvil cylinder and a knife cylinder facing each other. In order to punching a hole, a blade swivel having a punching blade and having an arc-shape section is disposed on the outer circumference face of the knife cylinder and a sheet to be processed is fed between the anvil cylinder and the knife cylinder rotating in opposite directions, so that a hole having a predetermined shape is punched.

Patent Literature 1 (Japanese Laid-Open Patent Publication No. HEI 8-229885) discloses fixing means for installing a blade swivel that fixes, when a blade swivel is to be installed to a knife cylinder of a rotary die cutter, the both ends of the blade swivel by means of fixing rings, which the requisite number of flat head bolts for fixing can be greatly reduced and a time required for installing the blade swivel can also be reduced.

The fixing means disclosed in Patent Literature 1 is designed for a blade swivel to punch a hole having a relatively large area and a relatively complex shape through a corrugated board sheet. For the above, even if time required to install the blade swivel to the knife cylinder is reduced, it still takes a considerable time to position and fix the blade swivel. Therefore, this technique is unsuitable for punching a small punching blade such as hand hole processing in a corrugated cardboard box maker.

Punching generates punched chips clogging the punching blade, so there is a need for removing the chips at a predetermined position and for preventing the chips from scattering.

Patent Literature 2 (Japanese Laid-Open Patent Publication No. 2006-130637) discloses means for removing punched chips that specifically has an elastic member disposed inside a circular punching blade installed in the blade swivel and ejecting remaining chips to exterior by resilience of the elastic member.

Patent Literature 3 (Japanese Laid-Open Patent Publication No. 2005-7543) discloses means in the form of an extruding rod disposed inside a knife cylinder and extruding punched chips out of the punching blade. Hereinafter, the configuration disclosed in Patent Literature 1 will now be described with reference to FIGS. 9 and 10.

In FIGS. 9 and 10, a rotary die cutter 200 is formed of an anvil cylinder 202 and a knife cylinder 204, which rotate in the directions that the respective arrows in FIG. 9 indicate. The outer circumference face of the knife cylinder 204 is detachably covered with an arc-section blade swivel 206 by means of bolt or others. To the blade swivel 206, a punching blade 208 that punches a predetermined shape through a corrugated board sheet S such as corrugated cardboard sheet fed between the anvil cylinder 202 and the knife cylinder 204, and, in an outer periphery of the punching blade 208, a holding tooth 210 that pierces and thereby holds punched chips a formed through punching by the punching blade 208 are mounted.

A chip ejecting arm 212 is attached to the outer circumference of the blade swivel 206 so as to be swingable around a supporting pin 214. A notch 216 that is accommodatable the holding tooth 210 is formed on the tip of the chip ejecting arm 212. A coil spring 218 is arranged in the vicinity of the chip ejecting arm 212. The coil spring 218 is supported by the holding pin 220 and a pressing end 222 of the coil spring 218 is in contact with the surface of the chip ejecting arm 212 to urge the chip ejecting arm 212 from outside.

The knife cylinder 204 and the blade swivel 206 each have a number of penetrating holes 226 in the radial direction. Inside each penetrating hole 226 being covered with the chip ejecting arm 212, an extruding rod 230 is placed. Each extruding rod 230 is in contact with the outer circumference face of an eccentric cylinder 232 contained in the knife cylinder 204. The eccentric cylinder 232 has a center of rotation eccentric to that of the knife cylinder 204, so that the rotation of the eccentric cylinder 232 extrudes the extruding rods 230 outward radially.

As depicted in FIG. 9, when the anvil cylinder 202 and the knife cylinder 204 are rotating in the respective directions that the arrows in FIG. 9 indicate and a corrugated board sheet S to be processed is forwarded to the space between the anvil cylinder 202 and the knife cylinder 204, the punching blade 208 installed in the blade swivel 206 forms a punching cut line on the sheet S, so that the inside of the punching cut line serves as a product portion and the outside of the punching cut line serves as punched chip a. The production portion is extruded from the inside of the punching blade 208 by the resilience of a non-illustrated elastic member installed inside the punching blade 208 while the punched chip a is transferred along the circumference direction of the knife cylinder 204, being pierced by the holding tooth 210.

Upon the punched chip a is transferred beneath the knife cylinder 204, the rotation of the eccentric cylinder 232 moves the extruding rod 230 outward in the radial direction, so that the chip ejecting arm 212 is swung outward and thereby the punched chip a is released from the holding tooth 210 to fall.

The extruding rod 230 is inserted or taken out when the chip ejecting arm 212 is swung in the upright direction. At that time, a stopper 224 fixed to the chip ejecting arm 212 is in contact with a pressing end 222 of the coil spring 218 to prevent the chip ejecting arm 212 from further swinging.

Unless punched chips a are ejected at a predetermined position, the punched chips a scatter around the rotary die cutter and hinder the operation of the rotary die cutter. In addition, there is a possibility of intruding punched chips into products.

### PRIOR ART REFERENCE

### Patent Literature

[Patent Literature 1] Japanese Laid-Open Patent Publication No. HEI 8-229885
[Patent Literature 2] Japanese Laid-Open Patent Publication No. 2006-130637
[Patent Literature 3] Japanese Laid-Open Patent Publication No. 2005-7543

### SUMMARY OF INVENTION

### Problems to be Solved by Invention

The means for fixing the blade swivel of Patent Literature 1 requires time and labor to install the blade swivel to the knife cylinder. For the above, if such fixing means is applied to simple punching of a hand hole as performed in a corrugated cardboard box maker, the box maker halts for a long time, leading to lowering in operation efficiency.

Means for removing punched chips disclosed in Patent Literature 2 is incapable of extruding punched chips out of the punching blade at constant timing due to a slight difference between the resilience of the elastic member and the constraint force on the punched chips of the punching blade. Consequently, the punched chips scatter around the rotary die cutter and hinder the operation of the rotary die cutter.

Means for removing punched chips disclosed in Patent Literature 3 has an advantage of not scattering punched chips a around the rotary die cutter because the punched chips a are ejected at a fixed point by the extruding rods 230. However, when the blade swivel 206 is to be attached or detached, the extruding rods 230 need to be inserted into and removed from the penetrating holes 226, which requires time to lower the operation efficiency.

A conventional device for removing punched chips in a rotary die cutter has penetrating holes that accommodate extruding rods on the entire outer circumference face at predetermined intervals on an outer periphery of the knife cylinder. When the blade swivel is to be installed, extruding rods are inserted into required penetrating holes, considering the shape of the blade swivel. After completion of punching, the extruding rods in the penetrating holes are removed and then the blade swivel is uninstalled.

As the above, extruding rods are placed at different positions with the shape of the blade swivel and are therefore frequently attached or detached each time the blade swivel is installed or replaced, which requires time to lower the operation efficiency.

Since the inner ends of the extruding rods are in contact with, for example, the extruding unit such as the eccentric cylinder, a large amount of eccentricity and a large amount of stroke cause much abrasion.

With the above technical problems in view, the object of the present invention is to rapidly position and fix a blade swivel to a knife cylinder. In particular, the first object is to improve the operation efficiency in punching by rapidly positioning and fixing a small blade swivel to be used for punching a hand hole in a corrugated cardboard box maker.

The second object is to abate abrasion of the inner ends of extruding members that are brought into contact with the extruding unit.

### Means to Solve the Problem

To attain the above objects, there is provided a device for installing a blade swivel of a rotary die cutter that includes a knife cylinder and an anvil cylinder that face each other and that punches a hole through a sheet fed between the knife cylinder and the anvil cylinder with a punching blade attached to a blade swivel having an arc-shape section installed to the outer circumference face of the knife cylinder, including: a plurality of first penetrating holes formed on the outer circumference of the knife cylinder; a plurality of first extruding members movably placed one inside each of the first penetrating holes; a second penetrating hole formed on the blade swivel and facing the plurality of first penetrating holes; a second extruding member movably placed inside the second penetrating hole and able to be brought into contact with the plurality of first extruding members to thereby prevent the second extruding member from projecting under the outer circumference face of the knife cylinder when the blade swivel is installed on the knife cylinder; an extruding unit that is disposed inside the knife cylinder and that extrudes the plurality of first extruding members (sic) to outside when the punched chip is to be extruded, so that the second extruding members extruded by the extruding unit extrude the punched chip remaining in the punching blade; a moving unit that moves the blade swivel on the knife cylinder along the longitudinal axis direction of the knife cylinder; a fixing unit that fixes the blade swivel to the knife cylinder; and a recess groove that is formed on the inner circumference face of the blade swivel along the axis direction of the knife cylinder and that faces the plurality of the first extruding members, so that the plurality of the first extruding members are out of contact from the blade swivel on the move.

In the device of the present invention, the moving unit moves the blade swivel on the knife cylinder along the axis direction of the knife cylinder and the fixing unit fixes the blade swivel on a desired position on the knife cylinder. This configuration eliminates requirement of fixing the blade swivel via a number of bolts as conventionally performed and reduces the time to install and uninstall the blade swivel.

Besides, in the device of the present invention, the first extruding members are previously placed inside almost all the first penetrating holes formed on the knife cylinder in advance and the second extruding member is also previously attached to the blade swivel. The time required for installing and uninstalling the blade swivel can be greatly reduced because attaching and detaching the first extruding members and the second extruding member can be eliminated.

The second extruding member after the blade swivel is installed so as not to project downward from the outer circumference of the knife cylinder, the second extruding member does not interfere with the movement of the blade swivel when the blade swivel moves on the knife cylinder.

The recess groove is formed on the inner circumference face of the blade swivel along the axis direction of the knife cylinder and that faces the opening of the second penetrating hole, so that the plurality of the first extruding members are out of contact from the blade swivel on the move. This configuration makes it possible to smoothly move the blade swivel on the knife cylinder and to reduce the time required for installing blade swivel to the knife cylinder.

In the device of the present invention, the extruding unit is one of an eccentric rotating member that rotates in conjunction with the knife cylinder, that has a center of rotation eccentric to that of the knife cylinder, and that has outer circumference face in a cylindrical form, and a cam that has an cam axis at the center of rotation of the knife cylinder, the eccentric rotating member or the cam extruding the plurality of first extruding member toward the knife cylinder.

Preferably, the device of the present invention may further include an extruding lever being fixed to the outer end of the second extruding member and having a first end pivotally supported by the surface of the blade swivel and a second end placed inside the punching blade through an opening on the punching blade, a portion of the extruding lever inside the punching blade extrudes the punched chip; and a stopper that stops the second extruding member in such position that the inner end of the second extruding member does not project inward from the outer circumference surface of the knife cylinder after the blade swivel is installed, wherein the opening regulates a moving stroke of the portion of the extruding lever inside the punching blade.

This simple configuration surely extrudes punched chips and concurrently, adjusting the distance from an axial fulcrum to the second end of the extruding lever and the distance from the axial fulcrum to the position of installing the second extruding member makes it possible to adjust an extruding force that the second extruding member applies to the extruding lever and an extruding stroke of the second portion of the extruding lever.

The presence of the holding unit prevents the inner end of the second extruding member from inwardly projecting from the outer circumference face of the knife cylinder. Consequently, the blade swivel can smoothly move on the knife cylinder.

The holding unit may be exemplified by a spring that urges the second extruding member.

Further preferably, the device of the present invention further includes a flexible material covering the inside of the recess groove so that possible noise caused by collision of the recess groove with the plurality of the first extruding member is reduced.

Further preferably, in the device of the present invention, at least one of the inner ends of the plurality of first extruding members which ends are to be brought into contact with the extruding unit, the outer ends of the plurality of the first extruding member which ends are to be brought into contact with the inner end of the second extruding member, and the inner end of the second extruding member which is to be brought into contact with the first extruding members may be formed of oilless lubricating resin or anti-abrasion material. With this configuration, abrasion of the inner or outer end of the first extruding members or the inner end of the second extruding member can be abated.

Examples of self-lubricating resin are so-called engineering plastics having a low coefficient of friction, such as polyethylene, polyacetal, polyamide, polybutylene terephthalate, and cast nylon.

Further preferably, the device of the present invention may further include a rotating member for reducing friction is disposed between the plurality of the first extruding members and the extruding unit or between the outer ends of the plurality of the first extruding members and the inner ends of the second extruding members that are to be brought into contact with each other. With this configuration, when the second extruding member is to move in conjunction with the blade swivel, the second extruding member is less caught by the first extruding members and concurrently, abrasion of the inner or outer end of each first extruding member or the inner end of the second extruding member can be abated.

Further preferably, in the device of the present invention, if the extruding unit is one of the above eccentric rotating member or a cam, an amount of friction between the plurality of first extruding members and the eccentric rotating member or between the plurality of first rotating members and the cam may be reduced by reducing an amount of eccentricity of the eccentric rotating member to the center of the knife cylinder or by reducing an amount of extruding by the cam. This simple configuration can abate abrasion of the inner end of each first extruding member.

Further preferably, in the device of the present invention, the device may be configured to reduce load on a contact face between the plurality of first extruding members and the extruding unit per unit area and thereby reduce an amount of abrasion of the contact face by increasing the area of the contact face. This simple configuration can also abate abrasion of the inner end of each first extruding member.

Further preferably, in the device of the present invention, the second extruding member may be in the form of a plate having a long side extending in a direction in which the blade swivel moves, having a beginning end, which comes to be contact with the plurality of first extruding members, in the form of one of a chamfer, an arc, and a concave-arc, or having an arc along the entire lower side. With this configuration, the second extruding member is less caught by the first extruding members.

Further preferably, in the device of the present invention, the inner ends or the outer ends of the plurality of first extruding members may be in spherical shapes or cone shapes. Thereby, abrasion of the inner end of each first extruding member can be abated. Otherwise, in case of possible contact of the outer end of each first extruding member with the second extruding member, the first extruding member can escape from being caught by the second extruding member.

Further preferably, in the device of the present invention, each of the plurality of first extruding members includes: a recess groove that is formed along the axis direction of the knife cylinder on the knife cylinder that faces the second extruding member; and a long plate that is embedded in the recess groove and that forms a plane sliding the second extruding member. Thereby, when the blade swivel moves on the knife cylinder, the second extruding members can smoothly move, keeping in contact with the sliding plane of the first extruding members, so that the second extruding member can escape from pulling out from the first extruding members.

Preferably, the device of the present invention may further include a holding unit that movably holds the plurality of first extruding members in the plurality of first penetrating holes or movably holds the second extruding member in the second penetrating hole. This configuration makes it possible to prevent the first extruding members or the second extruding member from falling from the blade swivel, so that the blade swivel can be smoothly installed and uninstalled.

There is provided a blade swivel of a rotary die cutter that includes a knife cylinder and an anvil cylinder that face each other and that punches a hole through a sheet fed between the knife cylinder and the anvil cylinder with a punching blade attached to a blade swivel installed to the outer circumference face of the knife cylinder, the rotary die cutter further including an extruding unit that extrudes punched chip remaining inside the punching blade to outside, the blade swivel including: a plurality of second penetrating holes formed at positions facing a number of first penetrating holes formed on the outer circumference of the knife cylinder when the blade swivel is installed to the knife cylinder; a plurality of second extruding members movably placed one inside each of the plurality of second penetrating holes and able to be brought into contact with the first extruding members movably placed one inside each of the first penetrating holes; and a recess groove that is formed on the inner circumference face of the blade swivel along the axis direction of the knife cylinder and that faces the first extruding members, wherein the plurality of second extruding members extrude the punched chip, and if the plurality of second extruding members outwardly project from the outer circumference of the knife cylinder when the blade swivel is moving, the blade swivel is out of contact from the knife cylinder.

The blade swivel of the present invention having the above configuration is applied to the device for installing the blade swivel of a rotary die cutter of the present invention. When the blade swivel is to be installed onto the knife cylinder, the presence of the recess groove allows the blade swivel to smoothly move on the axis direction of the knife cylinder on the knife cylinder. Consequently, the time required to install the blade swivel to the knife cylinder can be reduced.

Preferably, the device of the present invention may further include: an extruding lever being fixed to the outer ends of the plurality of second extruding members and having a first end pivotally supported by the surface of the blade swivel and a second end placed inside the punching blade through an opening on the punching blade, a portion of the extruding lever inside the punching blade extrudes the punched chip; and a number of stoppers, provided one for each of the plurality of second extruding members, that stop the plurality of second extruding members in such positions that the inner ends of the plurality of second extruding members do not project inward from the outer circumference surface of the knife cylinder after the blade swivel is installed, wherein the opening regulates a moving stroke of the portion of the extruding lever inside the punching blade.

Thereby, the mechanism for extruding punched chips can be simplified. Concurrently, adjusting the distance from an axial fulcrum to the second end of the extruding lever and the distance from the axial fulcrum to the position of installing the second extruding member makes it possible to adjust an extruding force that the second extruding member applies to the extruding lever and an extruding stroke of the second portion of the extruding lever.

The presence of the holding unit prevents the inner end of the second extruding member from inwardly projecting from the outer circumference face of the knife cylinder, so that the blade swivel can smoothly move on the knife cylinder.

### Effects of Invention

The device of the pre sent invention for installing a blade swivel of a rotary die cutter that includes a knife cylinder and an anvil cylinder that face each other and that punches a hole through a sheet fed between the knife cylinder and the anvil cylinder with a punching blade attached to a blade swivel having an arc-shape section installed to the outer circumference face of the knife cylinder, including: a plurality of first penetrating holes formed on the outer circumference of the knife cylinder; a plurality of first extruding members movably placed one inside each of the first penetrating holes; a second penetrating hole formed on the blade swivel and facing the plurality of first penetrating holes; a second extruding member movably placed inside the second penetrating hole and able to be brought into contact with the plurality of first extruding members to thereby prevent the second extruding member from projecting under the outer circumference face of the knife cylinder when the blade swivel is installed on the knife cylinder; an extruding unit that is disposed inside the knife cylinder and that extrudes the plurality of first extruding members (sic) to outside when the punched chip is to be extruded, so that the second extruding members extruded by the extruding unit extrude the punched chip remaining in the punching blade; a moving unit that moves the blade swivel on the knife cylinder along the longitudinal axis direction of the knife cylinder; a fixing unit that fixes the blade swivel to the knife cylinder; and a recess groove that is formed on the inner circumference face of the blade swivel along the axis direction of the knife cylinder and that faces the plurality of the first extruding members, so that the plurality of the first extruding members are out of contact from the blade swivel on the move. This configuration makes it possible to rapidly position and fix the blade swivel on the knife cylinder and to shorten the time for preparing punching, so that the operation efficiency of the rotary die cutter can be improved.

In particular, a small-sized blade swivel for punching hand holes in a corrugated cardboard box maker can rapidly be positioned and fixed, resulting in improvement in efficiency of punching process.

The blade swivel of the pre sent invention included in a rotary die cutter that includes a knife cylinder and an anvil cylinder that face each other and that punches a hole through a sheet fed between the knife cylinder and the anvil cylinder with a punching blade attached to a blade swivel installed to the outer circumference face of the knife cylinder, the rotary die cutter further including an extruding unit that extrudes punched chip remaining inside the punching blade to outside, the blade swivel comprising: a plurality of second penetrating holes formed at positions facing a number of first penetrating holes formed on the outer circumference of the knife cylinder when the blade swivel is installed to the knife cylinder; a plurality of second extruding members movably placed one inside each of the plurality of second penetrating holes and able to be brought into contact with the first extruding members movably placed one inside each of the first penetrating holes; and a recess groove that is formed on the inner circumference face of the blade swivel along the axis direction of the knife cylinder and that faces the first extruding members, wherein the plurality of second extruding members extrude the punched chip, and if the plurality of second extruding members outwardly project from the outer circumference of the knife cylinder when the blade swivel is moving, the blade swivel is out of contact from the knife cylinder. This configuration of the blade swivel attains the same effects as that of the above device.

### BRIEF DESCRIPTION OF DRAWINGS

FIG. 1 A front view of a rotary die cutter according to a first embodiment of the present invention;

FIG. 2 A perspective view of a blade swivel 18 of the first embodiment;

FIG. 3 A sectional view along a line A-A of FIG. 2;

FIG. 4 Views illustrating a second embodiment of the present invention;

FIG. 5 Perspective views illustrating a third embodiment of the present invention;

FIG. 6 Perspective views illustrating a fourth embodiment of the present invention;

FIG. 7 A longitudinal sectional view of a fifth embodiment of the present invention;

FIG. 8 A perspective view of a sixth embodiment of the present invention;

FIG. 9 A transverse sectional view of a conventional rotary die cutter; and

FIG. 10 A partial enlarged sectional view of the rotary die cutter of FIG. 9.

### PREFERRED EMBODIMENT TO CARRY OUT INVENTION

Hereinafter, the present invention will now be detailed with reference to embodiments illustrated in the accompanying drawing. However, size, material, shape, and relative positioning of each component of the embodiments should by no means be limited to those described throughout the specification unless specified.

### First Embodiment

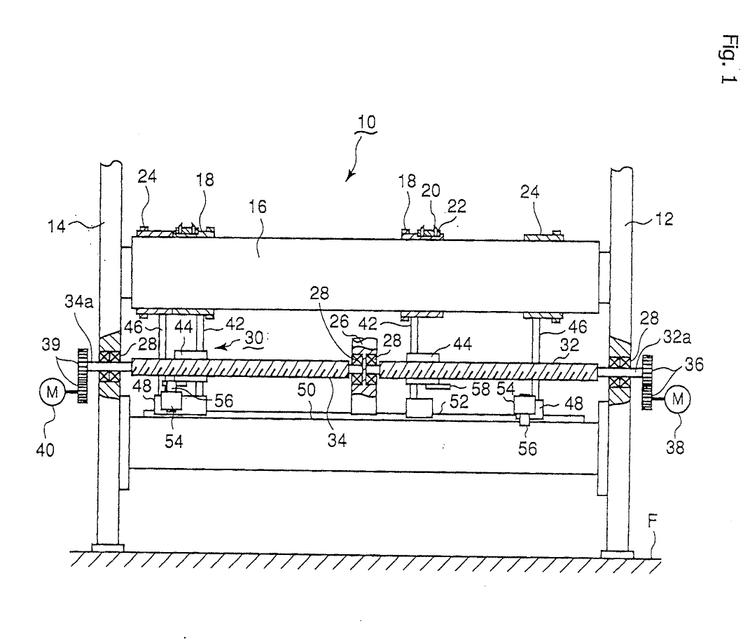

A device for installing a blade swivel of a rotary die cutter according to the first embodiment will now be described with reference to FIGS. 1-3. The rotary die cutter of the first embodiment is positioned at a die cutting unit disposed between a flexography unit and a folding unit that are components of a corrugated cardboard box maker, and forms hand holes of corrugated board sheets in the box maker.

As illustrated in FIG. 1, a rotary die cutter 10 of the first embodiment includes a knife cylinder 16 rotatably bridged between a driving-side supporting frame 12 and an operating-side supporting frame 14 that are vertically arranged on the floor F. Over the knife cylinder 16, a non-illustrated anvil cylinder is rotatably supported between the driving-side supporting frame 12 and the operating-side supporting frame 14. The rotary die cutter 10 rotates the knife cylinder 16 and the anvil cylinder in opposite directions and forms hand holes of corrugated sheets between the two cylinders while forwarding the sheets in the rotating direction.

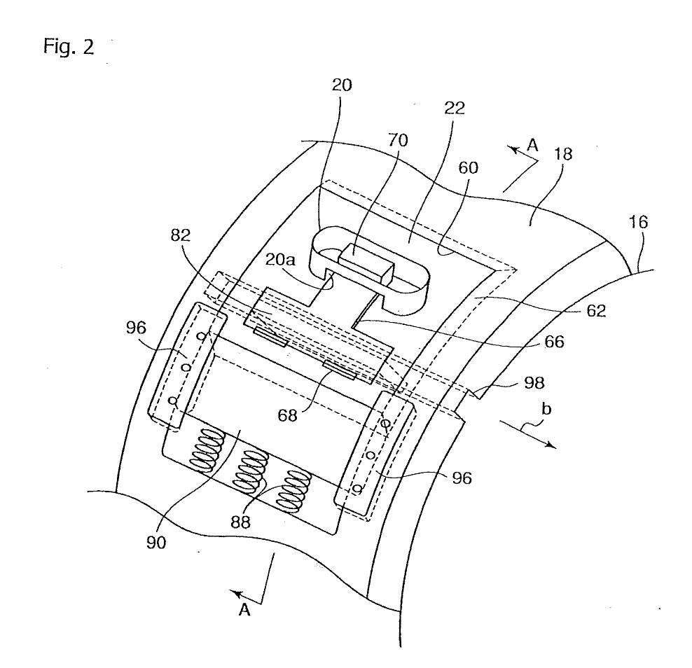

Two circular blade swivels 18 are disposed one on each of the left and right sides of the outer circumference face of the knife cylinder 16. Each blade swivel 18 is fitted to the knife cylinder 16 so as to be slidably along the longitudinal axis of the knife cylinder 16. As illustrated in FIGS. 2 and 3, a wooden pattern 22 in which a punching blade 20 is embedded is attached to each blade swivel 18.

Circular feeding bands 24 are disposed at the portion in vicinity of each end of the knife cylinder 16, and is fitted to the knife cylinder 16 so as to be slidably along the longitudinal axis of the knife cylinder 16. The feeding bands 24 sandwich, at the both end of the knife cylinder 16, the both ends of a corrugated board sheet being transferred with the anvil cylinder so that the corrugated board sheet is smoothly forwarded. At the outside of the driving-side supporting frame 12, a non-illustrated driving motor is disposed which rotates the knife cylinder 16.

A movable fixer 30 is disposed under the knife cylinder 16. The movable fixer 30 moves the blade swivels 18 along the longitudinal axis of the knife cylinder 16 and fixes the blade swivels 18 at respective setting positions. Hereinafter, the movable fixer 30 will now be detailed. In the knife cylinder 16 of FIG. 1, the two screw axes 32 and 34 are arranged in series along the longitudinal axis of the knife cylinder 16.

The screw axis 32 is bridged between the driving-side supporting frame 12 and a center frame 26, and is rotatably supported by a rotating bearing 28. The axis part 32a of the screw axis 32 extends to the outside of the driving-side supporting frame 12, and is connected to an output axis of a moving motor 38 via a pair of the transmission gears 36.

The screw axis 34 is bridged between the operating-side supporting frame 14 and the center frame 26, and is rotatably supported by a rotating bearing 28. The axis part 34a of the screw axis 34 is connected to an output axis of a moving motor 40 via a pair of transmission gears 39.

On each of the screw axes 32 and 34, a female thread formed inside a nut 44 is screwed. The rotation of the screw axes 32 and 34 moves the respective nuts 44 along the longitudinal axis of the knife cylinder 16. A yoke 42 is fixed to each nut 44. One end of each yoke 42 stops in a non-illustrated recess of the corresponding blade swivel 18. This configuration makes the blade swivel 18 possible to move along the longitudinal axis of the knife cylinder 16 in synchronization with the movement of the corresponding nut 44.

Each feeding band 24 is integrated with a connecting frame 46, which is connected to a movable carriage 48. Each movable carriage 48 is slidably supported on a rail 52, which is formed integrally with a stay 50 formed on the top surface of the stay 50. An air cylinder 54 is attached to each movable carriage 48. When a piston 56 of each air cylinder 54 extends downward, the lower end of the piston 56 presses against the top surface of the stay 50 and fixes the movable carriage 48 at the position.

When each blade swivel 18, which is screwed the screw axis 32 or 34, is moved to be brought into contact with the corresponding feeding band 24 by rotating the screw axis 32 or 34, the blade swivel 18 can unite with the corresponding feeding band 24 by extending the piston 56 upward and thereby coming into the recess formed on a connection 58 of the nut 44.

This configuration makes the blade swivels 18 possible to move along the longitudinal axis of the knife cylinder 16 and be thereby fixed in respective desired positions by rotating the screw axis 32 and screw axis 34. When the feeding bands 24 are to move to the both ends of a corrugated board sheet to match the width of the sheet, the blade swivels 18 are moved toward the respective feeding bands 24 so as to be in contact with the feeding bands 24, and then the pistons 56 are extended upward by operation of the respective air cylinders 54 so that the pistons 56 each unite with the corresponding nut 44.

Next, the feeding bands 24 are moved to desired positions along the axis direction of the knife cylinder 16 by moving the blade swivels 18. Upon the feeding bands 24 arrive at desired positions, the pistons piston 56 of the air cylinders 54 are extended downward to be disconnected from the corresponding nuts 44 and instead to press against the top surface of the stay 50 so that the feeding bands 24 are fixed in the positions.

Then, the feeding bands 24 are left in the fixed positions and the blade swivels 18 are moved to setting positions and are fixed in the setting positions by locking rotation of the screw axis 32 and 34.

According to the first embodiment, the two screw axes 32 and 34 arranged in series can position the blade swivels 18 and the feeding bands 24 to respective desired positions and fix the blade swivels 18 and the feeding bands 24 in the desired positions, so that a mechanism for moving feeding bands 24 can be omitted to simplify the entire device configuration.

Further, the blade swivel 18 can be positioned and fixed to the knife cylinder 16 rapidly, which reduces the time required for punching.

Next, description will now be made in relation to the configuration of the blade swivels 18 of the first embodiment with reference to FIGS. 2 and 3. In FIGS. 2 and 3, the inner circumference face of each blade swivel 18 has the same curvature as that of the outer circumference face 16a of the knife cylinder 16 so that the inner circumference face is in intimate contact with the outer circumference face 16a of the knife cylinder 16. An opening 60 to mount the wooden pattern 22 is formed on the blade swivel 18. The end face of the opening 60 along the circumference face of the blade swivel 18 has an overhang slope face 60a, which become narrower as approaching to the outside, and a vertical face 60b.

The end face 62 of the wooden pattern 22, which faces the end face of the opening 60, is formed of a plain slope face 62a, which has the same angle as that of the overhang slope face 60a and which faces overhang slope face 60a, and a vertical face 62b, which faces vertical face 60b.

An ellipse punching blade 20, which a hand hole through a corrugated board sheet, is embedded in the wooden pattern 22. The outer end of the punching blade 20 projects from the outer surface of the wooden pattern 22 and is capable of punching a hole through a corrugated board sheet. A resin extruding lever 66 is mounted on the outer surface of the wooden pattern 22. The extruding lever 66 is supported so as to pivot on a hinge 68 disposed on the outer surface of the wooden pattern 22. At the tip of the extruding lever 66, a resin extruding unit 70, which extrudes punched chips, is integrally formed with the extruding lever 66.

An opening 20a is drilled on a side face of the punching blade 20. The extruding lever 66 comes into the inside of the punching blade 20 through the opening 20a, so that the extruding unit 70 is arranged inside of the punching blade 20.

At the center of the hollow knife cylinder 16, an eccentric cylinder 72 is disposed along the axis direction of the knife cylinder 16. The eccentric cylinder 72 has the center of rotation being eccentric to the center of rotation of the knife cylinder 16. Rotation of the knife cylinder 16 moves the eccentric cylinder 72 in the radial direction of the knife cylinder 16 and thereby, the eccentric cylinder 72 extrudes a first extruding pin 74 that is to be described below in the radial direction of the knife cylinder 16.

As illustrated in FIG. 3, a number of first penetrating holes 76 are formed over the substantial entire region of the outer circumference face 16a of the knife cylinder 16 at predetermined intervals. First extruding pins 74 are previously placed in substantially all the first penetrating holes 76. The first penetrating holes 76 are formed at, for example, 50-mm intervals and can be adopted to any shape of a blade swivel. The first extruding pins 74 each take the form of a cylinder and have a wider portion 74a having a wider radial than that of the remaining portion at the lower end.

A hollow cylindrical screw clamp 78 is disposed at the outer opening of each first penetrating hole 76. The screw clamp 78 has a penetrating hole in the center to allow the first extruding pin 74 therethrough and has a threaded outer circumference face, which is screwed with a tapped hole formed on the first penetrating hole 76. This configuration stops the wider portion 74a in the screw clamp 78 to prevent each first extruding pin 74 from ejecting from the outer opening of the first penetrating hole 76.

On each blade swivel 18, a number of second penetrating holes 80 are formed along the radial direction of the blade swivel 18 at the positions facing the outer openings of the first penetrating holes 76. A second extruding rod 82, which is to be inserted into each of the second penetrating holes 80 is fixed to the back face of the extruding lever 66. As illustrated in FIG. 2, the second extruding rod 82 is in the form of a long plate having a long side extending in the axis direction of the knife cylinder 16, and is made of self-lubricating resin. Accordingly, each second penetrating hole 80 also take the shape having a long side extending in the axis direction of the knife cylinder 16 so as to be accommodatable the second extruding rod 82

A coil spring 84 is installed on the back face of the extruding lever 66. The coil spring 84 is accommodated in a cylindrical recess 86 formed on the outer circumference face 22a of the wooden pattern 22. The resilience of the coil spring 84 adjusts the inner end 82a of the second extruding rod(s) 82 not to project from the bottom 22b of the wooden pattern 22 and also adjusts the extruding unit 70, which is integral with the extruding lever 66 at the tip of the extruding lever 66, to slightly projects from the tip of the punching blade 20 after the blade swivel 18 is installed to the knife cylinder 16.

For example, when the center axis of the eccentric cylinder 72 is vertically deviated by 10 mm from the center axis of the knife cylinder 16, the eccentric stroke of the eccentric cylinder 72 is 20 mm.

A fixing stopper 90 is installed via coil springs 88 to the blade swivel 18 so as to be slidably on the knife cylinder 16 along the circumference direction of the knife cylinder 16. The end face 91 of the fixing stopper 90, the face 91 facing the end face 62 of the wooden pattern 22, is formed of an overhang slope 91a, which faces the plain slope face 62a and which has the same angle as that of the plain slope face 62a, and an upright face 91b. The overhang slope face 60a of the opening 60 and the overhang slope 91a of the fixing stopper 90 cooperatively sandwich and thereby fix the wooden pattern 22.

One end of an operation tool 92 for the fixing stopper 90 is connected to the fixing stopper 90 while the other end of the operation tool 92 is connected to a clamp 94. The fixing stopper 90 is urged by the resilience of the coil springs 88 in such a direction that the fixing stopper 90 presses toward the wooden pattern 22. When the wooden pattern 22 is to be attached or detached, folding the clamp 94 in the direction of the arrow c disconnects the fixing stopper 90 from the wooden pattern 22, which is thereby released from the fixing.

As illustrated in FIG. 2, rails 96 are fixed to the blade swivel 18 at the both sides of the fixing stopper 90. The rails 96 guide the movement of the fixing stopper 90 along the circumference direction of the knife cylinder.

In each blade swivel 18 and the corresponding wooden pattern 22, a recess groove 98 having a rectangular section along the axis direction of the knife cylinder 16 is formed at the inner opening of the second penetrating holes 80. The breadth of the recess groove 98 is set to be larger than that of the second penetrating holes 80, which avoids contact of the first extruding pins 74, when the first extruding pins 74 project upwardly from the outer opening of each first penetrating hole 76, with the recess groove 98 itself.

For example, assuming that the eccentric stroke of the eccentric cylinder 72 is 20 mm and that the first extruding pins 74 project upwardly from the outer openings of the respective first penetrating holes 76 by 3 mm at the maximum, the depth of the recess groove 98 is set to be 6 mm, that is twice of the extent of projecting of the first extruding pins 74.

On the inner face of the recess groove 98, the face facing the first extruding pins 74, a rubber sheet 100 is pasted to cushion the inner face against the first extruding pin 74 in case of possible collision to lessen noise caused from the collision.

In the blade swivel 18 of the first embodiment, when the wooden pattern 22 is to be installed, the clamp 94 is folded in the direction of arrow c to widen the opening 60, and the wooden pattern 22 is inserted into the widened opening 60. Then the clamp 94 is returned in the direction of the arrow d, so that the end face of the opening 60 is pressed against the end face of the wooden pattern 22 by the resilience of the coil springs 88. Consequently, the wooden pattern 22 is clamped from the both side of the wooden pattern 22 to be fixed. This configuration makes it possible to fix the wooden pattern 22 to the blade swivel 18 with a single action.

After the wooden pattern 22 is installed to the blade swivel 18, the blade swivel 18 is moved to a predetermined position along the axis direction of the knife cylinder 16 and fixed in the position in the above manner. Even when the first extruding pin 74 projects from the outer circumference face of the knife cylinder 16, the presence of the recess groove 98 on the inner circumference face of the blade swivel 18 avoids contact of the inner circumference face of the blade swivel 18 with the first extruding pin 74, so that the blade swivel 18 can smoothly move along the longitudinal axis (in the direction of arrow b) of the knife cylinder 16. Accordingly, the blade swivel 18 can be rapidly positioned and fixed to the knife cylinder 16, so that the down time of the rotary die cutter 10 can be shortened to enhance the operation efficiency.

When the box maker is operating, the punching blade 20 punches a predetermined part in a corrugated board sheet which is feed into the space between the non-illustrated anvil cylinder and the knife cylinder 16 to form a hand hole. After the punching, a punched chip a is left being caught in the inner region 64 of the punching blade 20. After the punching, the eccentric cylinder 72 comes outward of the knife cylinder 16 in the radial direction to extrude the inner end of the first extruding pin 74. Consequently, the first extruding pin 74 comes into contact with the second extruding rod 82, which is thereby extruded to the outside. Accordingly, the extruding unit 70 of the extruding lever 66 is extruded outside of the blade swivel 18, and the punched chip is extruded from the punching blade 20. In this case, the moving stroke of the extruding unit 70 is restricted in terms of the opening width of the opening 20a.

As the above, punched chips a are extruded at predetermined extruding timing. The extruded punched chips a does not disperse around the rotary die cutter 10 and the chips are accurately extruded into the non-illustrated wastebasket.

According to the first embodiment, after the blade swivel 18 is installed to the blade swivel 16, the second extruding rods 82 are held so as not to project inward from the outer circumference face of the knife cylinder 16 by the resilence of the coil springs 84, the movement of the blade swivel 18 on the knife cylinder 16 is not hindered. In addition, even if the first extruding pin 74 projects from the outer circumference face of the knife cylinder 16, the presence of the recess groove 98 makes it possible to avoid hindrance to the movement of the blade swivel 18. Thereby, the blade swivel 18 can be rapidly installed to the knife cylinder 16.

The resilience of the coil spring 84 can always prevent the second extruding member 36 (sic) form projecting from the inner circumference face of the blade swivel 18, which can thereby smoothly move.

Besides, since the first extruding pins 74 are previously placed in almost all the first penetrating holes 76 and the second extruding rods 82 are also previously placed in the second penetrating holes 80, there is no need to install and uninstall the first extruding pins 74 and second extruding rod 82 when the blade swivel 18 is to be attached and detached. Consequently, it is possible to largely reduce time required to attach and detach the blade swivel 18.

Since the screw clamps 78 are formed at the outer openings of the first penetrating holes 76 and can stop the wider portions 74a of the first extruding pins 74 in the screw clamps 78, it is possible to surely prevent first extruding pins 74 from being pulled out.

In addition, since the rubber sheet 100 is pasted on the inner face of the recess groove 98 that faces each of the first extruding pins 74, it is possible to cushion the inner face against the first extruding pin 74 in case of possible collision with the inner face to lessen noise caused from the collision.

The second extruding rods 82 are made of self-lubricating resin having a low coefficient of friction, and therefore abrasion of the second extruding rods 82 can be reduced. If the first extruding pins 74 are also made of self-lubricating resin, it is possible reduce the abrasion of the inner end and the outer end of each of the first extruding pins 74, which are respectively brought into contact with the eccentric cylinder 72 and the second extruding rods 82.

Since the inner end of each first extruding pin 74 is the wider portion 74a, the load of the eccentric cylinder 72 on the wider portion 74a per unit area can be reduced and thereby abrasion of the inner end can be reduced.

Besides, abrasion of the inner ends of the first extruding pin 74 can be reduced by reducing an amount of eccentricity of the eccentric cylinder 72 to the center of rotation of the knife cylinder 16.

Further, each second extruding rod 82 takes the form of a plate having a long side along the axis direction of the knife cylinder 16. With the above configuration, even if the first extruding pin 74 is disposed at a position slightly deviated in the axis direction of the knife cylinder 16 from the corresponding second extruding rod 82, the first extruding pin 74 can be in precise contact with the second extruding rod 82. While the blade swivel 18 is moving, maintaining the contact of the second extruding rod 82 with the first extruding member 74 makes it possible to move the blade swivel 18.

### Second Embodiment

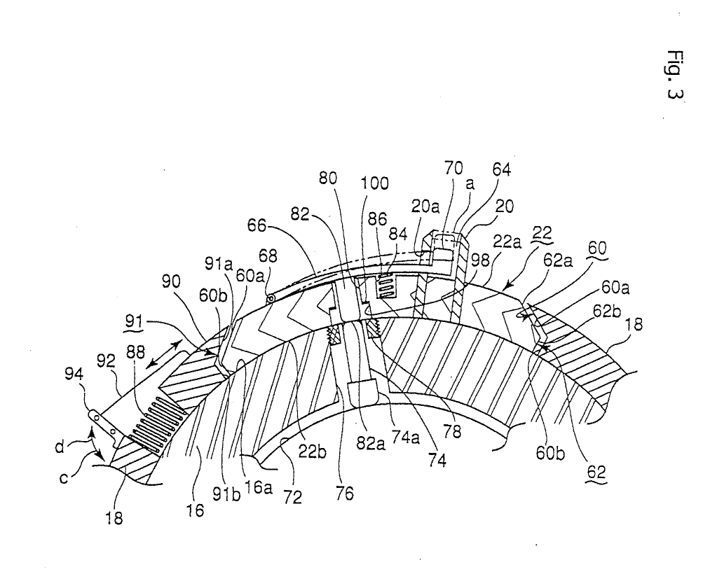

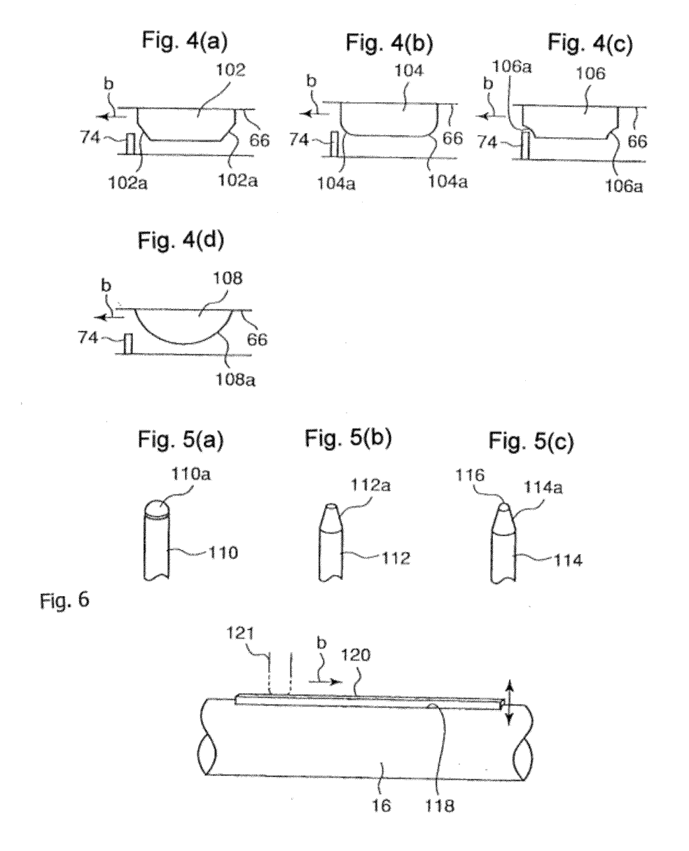

Next, a second embodiment of the present invention will now be described with reference to FIG. 4, which illustrates modifications of the second extruding rod 82 to the first embodiment. The second extruding rods 82 of FIGS. 4(a)-4(d) each take a form of a plate having a longer side arranged along the direction (of arrow b) in which the blade swivel 18 being installed moves likewise the second extruding rod 82 of the first embodiment.

A second extruding member 102 of FIG. 4(a) has chambered oblique corners 102a, which can prevent the second extruding member 102 from being caught when the second extruding member 82 (sic) is brought into contact with the first extruding pin 74 while the blade swivel 18 is on the move.

A second extruding member 104 of FIG. 4(b) in the form of a long plate has arc-shaped corners 104a for the same purpose.

A second extruding member 106 of FIG. 4(c) in the form of a long plate has concave-arc corners 106a, which can prevent the second extruding member 106 from being caught when the second extruding member 106 is brought into contact with the first extruding pin 74.

A second extruding member 108 of FIG. 4(d) has a longer side in the form of semiellipse 108a, which can prevent the second extruding member 108 from being caught when the second extruding member 108 is brought into contact with the first extruding pin 74.

### Third Embodiment

Next, a third embodiment of the present invention will now be described with reference to FIG. 5, which illustrates modifications of the first extruding pin 74 to the first embodiment. A first extruding rod 110 of FIG. 5(a) has a spherical outer end 110a, which inhibits the cylindrical first extruding rod 110 from being caught when the first extruding rod 110 is brought into contact with the second extruding rod 82, resulting in reduction of abrasion of the first extruding rod 110 when colliding with the second extruding member.

A first extruding rod 112 of FIG. 5(b) has a taper (cone-shape) chamfer 112a on edge, which prevents the first extruding rod 112 from being caught by the second extruding member.

A first extruding rod 114 of FIG. 5(c) has an outer end in the form of a taper chamfer 114a on the tip of which a recess is formed, a spherical ball 116 made of anti-abrasion material being fitted to the recess. With this configuration, when the first extruding rod 114 collides with the second extruding member, rotation of the ball 116 prevents the second extruding rod 114 from being caught by the second extruding rod and concurrently reduces friction of the outer end of the first extruding rod 114.

Application of each of the modifications of FIGS. 5(a)-5(c) to the inner end of the first extruding rod abates abrasion of the first extruding rods.

### Fourth Embodiment

Next, a fourth embodiment of the present invention will now be described with reference to FIG. 6, which illustrates an additional modifications of the first extruding pin 74 to the first embodiment. In FIG. 6, a long recess groove 118 is formed along the longitudinal axis direction on the top of the knife cylinder 16, and a first extruding member 120 in the form of a long rectangular is fitted to the recess groove 118. The top surface of the first extruding member 120 serves as a sliding surface that is to be brought into contact with the second extruding member when the first extruding member 120 collides with the second extruding member. The first (sic) extruding member is a rod-shape second extruding rod 121.

When the blade swivel 18 is to be installed, the inner end of the second extruding rod 121, being in contact with the top surface of the first extruding member 120, moves in the direction of arrow b, so that the second extruding rod 121 does not fall from the first extruding member 120 and the blade swivel 18 can smoothly move. Furthermore, the first extruding member 120 can be easily processed.

### Fifth Embodiment

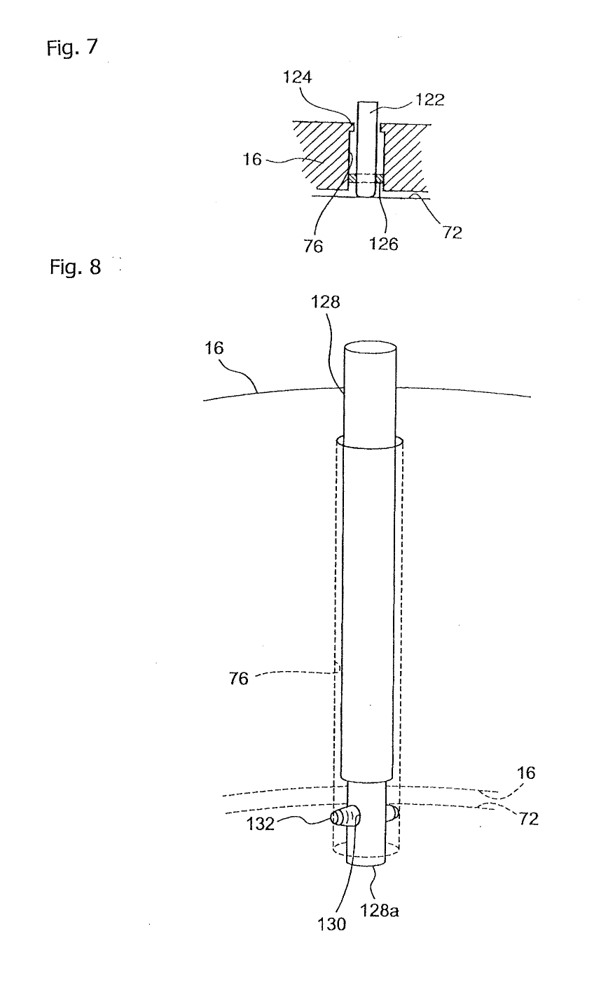

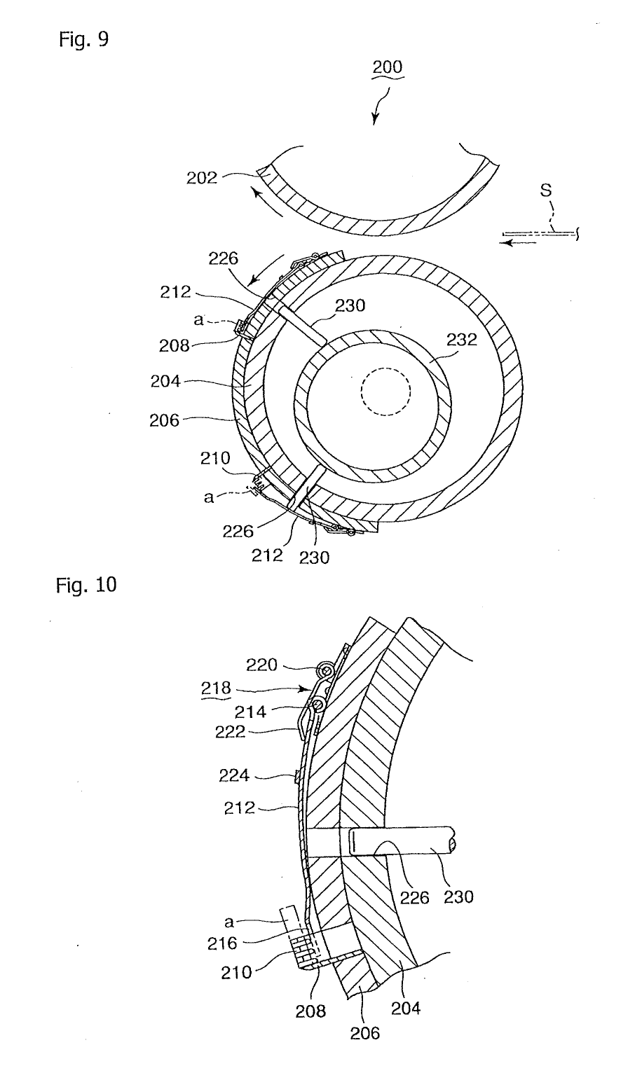

Next, a fifth embodiment of the present invention will now be described with reference to FIG. 7, which illustrates different means for preventing the first extruding pin 74 placed in the first penetrating hole 76 from pulling out of that of the first embodiment. In FIG. 7, a narrow portion 124 is formed at the outer opening of the first penetrating hole 76. A rubber ring 126, which has an inside diameter smaller than the outside diameter of the first extruding rod 122 and which is currently widened, is fitted in a position in the vicinity of the lower end of the cylindrical first extruding rod 122. The resilience of the rubber ring 126 firmly tightens the rubber ring 126 itself around the cylindrical first extruding rod 122, so that the rubber ring 126 is fixed to the first extruding rod 122.

Since the outside diameter of the rubber ring 126 is smaller than the inside diameter of the first penetrating hole 76, the first extruding rod 122 is movable inside the first penetrating hole 76. In addition, the outer diameter of the rubber ring 126 is larger than the opening of the narrow portion 124, the second extruding rod 122 does not pull out of the narrow portion 124. The first extruding rod 122 can be prevented from pulling out by the above simple configuration.

### Sixth Embodiment

Next, a sixth embodiment of the present invention will now be detailed with reference to FIG. 8. The sixth embodiment concerns further different means for preventing the first extruding pin 74 placed inside the first penetrating hole 76 from pulling out. As depicted in FIG. 8, the first penetrating hole 76 does not have a narrow portion, but instead a cylindrical first extruding rod has a narrow-diameter portion 128 (sic) at the lower end of the cylindrical first extruding rod 128. A penetrating hole 130 is horizontally drilled on the narrow-diameter portion 128 (sic), and a rubber rod 132 is press-fitted through the penetrating hole 130. Since the size of the rubber rod 132 is larger than the inner diameter of the first penetrating hole 76, the both ends of the rubber rod 132 are in intimate contact with the inner wall of the first penetrating wall of the first penetrating hole 76 so that the resilience of the rubber rod 132 fixes the first extruding pin 74 (sic) in the first penetrating hole 76.

In order to pull out the first extruding rod 128 from the first penetrating hole 76, an operator pulls out the rod by hand when the eccentric cylinder 72 extrudes the first extruding rod 128 and thereby the head portion of the first extruding rod 128 extruded from the first penetrating hole 76.

According to this embodiment, the absence of a narrow portion in the first penetrating hole 76 makes it easy to pull out the first extruding rod 128 and makes the rubber rod 132 to firmly fix the first extruding rod 128 to the first penetrating hole 76.

In the above first embodiment, abrasion of the first extruding pin 74 and the second extruding rod 82 is reduced by forming the pin 74 and the rod 82 of self-lubricating resin. Alternatively, the first extruding pin 74 and the second extruding rod 82 may be made of another anti-abrasion material.

For example, first extruding pin 74 and the second extruding rod 82 may be made of nylon resin such as Cast nylon (trade name, product of Mitsuboshi Belting Ltd.); anti-abrasion resin such as Duracon (trade name, product of Polyplastics Co., Ltd.); copper alloy such as phosphorus-bronze alloy casting; carbon material; iron material such as cast iron.

### INDUSTRIAL APPLICABILITY

When the rotary die cutter punches holes, the present invention can rapidly install the blade swivel to the knife cylinder, which thereby can enhance the operation efficiency in punching.

1. A device for installing a blade swivel of a rotary die cutter that includes a knife cylinder and an anvil cylinder that face each other and that punches a hole through a sheet fed between the knife cylinder and the anvil cylinder with a punching blade attached to a blade swivel having an arc-shape section installed to the outer circumference face of the knife cylinder, comprising:
a plurality of first penetrating holes formed on the outer circumference of the knife cylinder;
a plurality of first extruding members movably placed one inside each of the first penetrating holes;
a second penetrating hole formed on the blade swivel and facing the plurality of first penetrating holes;
a second extruding member movably placed inside the second penetrating hole and able to be brought into contact with the plurality of first extruding members to thereby prevent the second extruding member from projecting under the outer circumference face of the knife cylinder when the blade swivel is installed on the knife cylinder;
an extruding unit that is disposed inside the knife cylinder and that extrudes the plurality of the second extruding rod to outside when the punched chip is to be extruded, so that the second extruding members extruded by the extruding unit extrude the punched chip remaining in the punching blade;
a moving unit that moves the blade swivel on the knife cylinder along the longitudinal axis direction of the knife cylinder;
a fixing unit that fixes the blade swivel to the knife cylinder; and
a recess groove that is formed on the inner circumference face of the blade swivel along the axis direction of the knife cylinder and that faces the plurality of the first extruding members, so that the plurality of the first extruding members are out of contact from the blade swivel on the move.

2. The device according to claim 1, further comprising:
an extruding lever being fixed to the outer end of the second extruding member and having a first end pivotally supported by the surface of the blade swivel and a second end placed inside the punching blade through an opening on the punching blade, a portion of the extruding lever inside the punching blade extrudes the punched chip; and
a stopper that stops the second extruding member in such position that the inner end of the second extruding member does not project inward from the outer circumference surface of the knife cylinder after the blade swivel is installed, wherein
the opening regulates a moving stroke of the portion of the extruding lever inside the punching blade.

3. The device according to claim 1, further comprising a flexible material covering the inside of the recess groove so that possible noise caused by collision of the recess groove with the plurality of the first extruding member is reduced.

4. The device according to claim 1, wherein at least one of the inner ends of the plurality of first extruding members which ends are to be brought into contact with the extruding unit, the outer ends of the plurality of the first extruding member which ends are to be brought into contact with the inner end of the second extruding member, and the inner end of the second extruding member which is to be brought into contact with the first extruding members is formed of oilless lubricating resin or anti-abrasion material.

5. The device according to claim 1, further comprising a rotating member for reducing friction is disposed between the plurality of the first extruding members and the extruding unit or between the outer ends of the plurality of the first extruding members and the inner ends of the second extruding members that are to be brought into contact with each other.

6. The device according to claim 1, wherein:
the extruding unit is one of an eccentric rotating member that rotates in conjunction with the knife cylinder, that has a center of rotation eccentric to that of the knife cylinder, and that has outer circumference face in a cylindrical form, and a cam that has an cam axis at the center of rotation of the knife cylinder, the eccentric rotating member or the cam extruding the plurality of first extruding member toward the knife cylinder; and
an amount of friction between the plurality of first extruding members and the eccentric rotating member or between the plurality of first rotating members and the cam is reduced by reducing an amount of eccentricity of the eccentric rotating member to the center of the knife cylinder or by reducing an amount of extruding by the cam.

7. The device according to claim 1, wherein the device is configured to reduce load on a contact face between the plurality of first extruding members and the extruding unit per unit area and thereby reduce an amount of abrasion of the contact face by increasing the area of the contact face.

8. The device according to claim 1, wherein the second extruding member is in the form of a plate having a long side extending in a direction in which the blade swivel moves, having a beginning end, which comes to be contact with the plurality of first extruding members, in the form of one of a chamfer, an arc, and a concave-arc, or having an arc along the entire lower side.

9. The device according to claim 1, wherein the inner ends or the outer ends of the plurality of first extruding members are in spherical shapes or cone shapes.

10. The device according to claim 1, wherein each of the plurality of first extruding members includes: a recess groove that is formed along the axis direction of the knife cylinder on the knife cylinder that faces the second extruding member; and a long plate that is embedded in the recess groove and that forms a plane sliding the second extruding member.

11. The device according to claim 1, further comprising a holding unit that movably holds the plurality of first extruding members in the plurality of first penetrating holes or movably holds the second extruding member in the second penetrating hole.

12. A blade swivel of a rotary die cutter that includes a knife cylinder and an anvil cylinder that face each other and that punches a hole through a sheet fed between the knife cylinder and the anvil cylinder with a punching blade attached to a blade swivel installed to the outer circumference face of the knife cylinder, the rotary die cutter further including an extruding unit that extrudes punched chip remaining inside the punching blade to outside, the blade swivel comprising:
a plurality of second penetrating holes formed at positions facing a number of first penetrating holes formed on the outer circumference of the knife cylinder when the blade swivel is installed to the knife cylinder;
a plurality of second extruding members movably placed one inside each of the plurality of second penetrating holes and able to be brought into contact with the first extruding members movably placed one inside each of the first penetrating holes; and
a recess groove that is formed on the inner circumference face of the blade swivel along the axis direction of the knife cylinder and that faces the first extruding members, wherein
the plurality of second extruding members extrude the punched chip, and
if the plurality of second extruding members outwardly project from the outer circumference of the knife cylinder when the blade swivel is moving, the blade swivel is out of contact from the knife cylinder.

13. The blade swivel according to claim 12, further comprising:
an extruding lever being fixed to the outer ends of the plurality of second extruding members and having a first end pivotally supported by the surface of the blade swivel and a second end placed inside the punching blade through an opening on the punching blade, a portion of the extruding lever inside the punching blade extrudes the punched chip; and
a number of stoppers, provided one for each of the plurality of second extruding members, that stop the plurality of second extruding members in such positions that the inner ends of the plurality of second extruding members do not project inward from the outer circumference surface of the knife cylinder after the blade swivel is installed, wherein
the opening regulates a moving stroke of the portion of the extruding lever inside the punching blade.
